(19) United States
(12) Patent Application Publication
(10) Pub. No.: US 2013/0062004 A1
(43) Pub. Date: Mar. 14, 2013

(54) AERODYNAMIC SURFACES HAVING DRAG-REDUCING RIBLETS AND METHOD OF FABRICATING THE SAME

(71) Applicants: David H. Amirehteshami, Rossmoor, CA (US); Roger A. Burgess, Long Beach, CA (US); Branko Sarh, Huntinagton Beach, CA (US)

(72) Inventors: David H. Amirehteshami, Rossmoor, CA (US); Roger A. Burgess, Long Beach, CA (US); Branko Sarh, Huntinagton Beach, CA (US)

(73) Assignee: The Boeing Company

(21) Appl. No.: 11/954,330

(22) Filed: Dec. 12, 2007

(51) Int. Cl. B29C 70/84

(52) U.S. Cl. 156/245

(57) ABSTRACT

Riblets may be formed in aerodynamic surfaces to reduce drag by forming a composite material layup, molding the riblets into a surface of the layup, and curing the layup.

### TECHNICAL FIELD

This disclosure generally relates to aerodynamic surfaces on aircraft, and deals more particularly with a method of producing drag reducing features on the surface of composite structures.

### BACKGROUND

The use of aerodynamic features on the outer skin and components of aerospace vehicles are known to increase efficiency by reducing drag caused from surface friction. For example, the introduction of riblets into an aircraft's outer skin may reduce drag a modest amount by reducing skin friction exerted by a turbulent boundary layer at the surface of the skin. The riblets tend to inhibit lateral turbulent motions near the bottom of the boundary layer, which primarily comprise the motions associated with the near-wall streamwise vortices, thereby reducing the overall rate of turbulence in the boundary layer by a modest percentage. These relatively small reductions in drag may improve operating efficiency sufficient to generate significant savings in fuel costs.

The riblets mentioned above typically comprise a pattern of very small, alternating ridges and grooves aligned longitudinally, approximately in the direction of airflow over aerodynamic surfaces on the aircraft, such as the leading edges of wings and stabilizers. In the past, riblets have been placed on aerodynamic surfaces by forming V-shaped ridges in a flexible film. The film may be placed on the aerodynamic surfaces, typically using an adhesive or other means. This practice is relatively labor intensive since it requires separate steps for manufacturing the film and then placing the film on the aircraft. In addition, problems may be encountered due to improper alignment of the riblets relative to the direction of airflow. Finally, these films may not possess sufficient durability, particularly in commercial and military aircraft applications, thus requiring maintenance and/or frequent replacement of the film.

Accordingly, there is a need for a method of producing drag reducing riblets on aerodynamic surfaces of aircraft which is economical, repeatable and reliable.

### SUMMARY

A method is provided for producing drag reducing riblets on aerodynamic surfaces of aircraft and other aerospace vehicles. The riblets may be integrally formed with aircraft skins fabricated by molding layups of composite materials. Because the riblets are integrally molded with the aircraft's outer skin at the time the skin is manufactured, fabrication effort is reduced and the riblets are reliably and repeatably aligned on the skin. Furthermore, by forming the desired riblet features in the surfaces of permanent tooling, feature dimensions of the riblets can be closely controlled, which contributes to achieving repeatable, consistent results.

In accordance with one disclosed method embodiment, riblets are formed in aerodynamic surfaces of an aircraft to reduce drag by the steps comprising: forming a composite material layup; molding the riblets into a surface of the layup; and, curing the layup. The method may further comprise forming a plurality of grooves in the surface of the tool which is then used to mold the riblets into the surface of the layup. A layer of moldable material may be applied over the layup, or to the tool, which is then used to mold the riblets. The riblets may be covered with a paint and/or UV inhibitor by applying the paint/UV inhibitor to the grooved tool surface before the layup is molded.

According to another method embodiment, aerodynamic surface features may be formed on the outer skin of an aircraft by the steps comprising: molding a generally rigid part having the approximate shape of the skin and including an outer surface having a plurality of substantially parallel riblets over which air may flow; and, applying the part to the skin. The step may further comprise forming a plurality of substantially parallel grooves in the surface of a tool and then using the tool to mold the rigid part. The method may also include the steps of forming a layup of composite materials, compacting the layup and the part in a mold, and co-curing the part in the layup. The part may be directly applied to a section of the aircraft skin after removing a layer of material from the skin.

Another disclosed embodiment provides a method of reworking an outer skin of an aircraft, comprising the steps of: removing a layer of material from a section of the skin; molding an insert having the same general shape as the layer of the material that has been removed, including forming a plurality of riblets in the outer surface of the insert; and, replacing the layer of material with the insert. The method may also include grinding away riblets that are present on the skin before the insert is applied.

In accordance with another disclosed embodiment, an aerodynamic structure is provided for use in aerospace applications, comprising an outer skin including integrally formed, substantially parallel riblets extending in the direction of airflow over the skin. The riblets may include sidewalls forming an acute angle that may be between approximately 25 degrees and 35 degrees. The riblets may have a height of between 0.0018 inches and 0.00135 inches. The centerlines of the riblets may be spaced apart between approximately 0.00285 inches and 0.00315 inches. The base of the riblets may have a width less than approximately 0.001 inches. The outer skin may further include integrally formed, substantially flat grooves between the riblets extending in the direction of airflow over the skin.

The disclosed embodiments satisfy the need for a method of producing drag reducing riblets on aerodynamic surfaces that is economical, repeatable and reliable.

Various additional objects, features and advantages of the disclosed embodiments can be more fully appreciated with reference to the detailed description and accompanying drawings that follow.

### BRIEF DESCRIPTION OF THE DRAWINGS

FIG. 1 is a perspective view showing typical locations where riblets may be provided on aerodynamic surfaces of an aircraft.

FIG. 2 is a cross sectional, perspective illustration of an aircraft skin having riblets formed on the outer surface thereof.

FIG. 3 is a perspective view better showing the geometry of the riblets illustrated in FIG. 2.

FIG. 4 is a cross sectional view taken along the line 4-4 in FIG. 3.

FIG. 4a is an enlarged view of the area designated as “A” in FIG. 4.

FIG. 5 is a graph illustrating the change in drag reduction for riblets of various sharpnesses.

FIG. 6 is a perspective view of a mold tool provided with grooves for molding the riblets.

FIG. 7 is a side view of a composite layup in a mold in which riblets are molded from an adhesive applied over the layup.

FIG. 8 is a flow diagram of a method for molding the riblets in the surface of the layup as illustrated in FIG. 7.

FIG. 9a illustrates a film or foil used as a tool to mold riblets.

FIGS. 9b and 9c diagrammatically illustrate steps for forming the foil/film shown in FIG. 9a.

FIG. 10 is a view similar to FIG. 7 but depicting an alternate method for placing riblets on an aircraft skin.

FIG. 11 is a flow diagram illustrating an alternate method for forming the riblets.

FIG. 12 is a side view of a portion of an aircraft wing illustrating the application of rigid parts containing riblets to the aircraft's skin.

FIG. 13 is a sectional view of a portion of an aircraft wing, showing a portion of the skin having been removed to receive a rigid part containing riblets.

FIG. 14 is a flow diagram illustrating a method of reworking an aircraft skin to add riblets.

FIG. 15 is a flow diagram of aircraft production and service methodology.

FIG. 16 is a block diagram of an aircraft.

### DETAILED DESCRIPTION

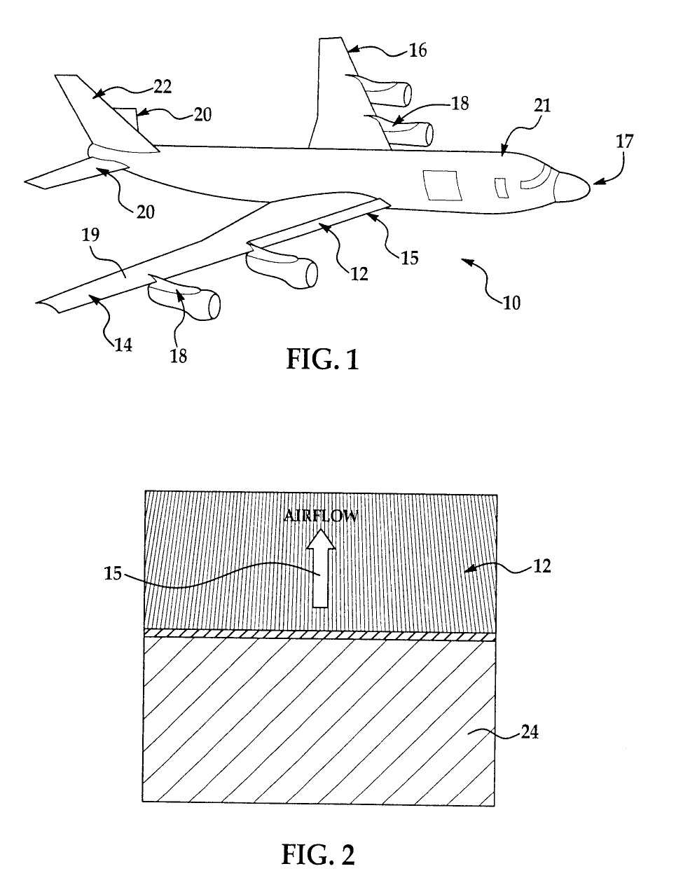

Referring first to FIG. 1, embodiments of the disclosure relate to riblets 12 applied to aerodynamic surfaces 15 of an aerospace vehicle such as the aircraft 10. The aerodynamic surfaces 15 may comprise any of the outer skin surfaces on the aircraft 10 where drag may be advantageously reduced, such as a nose 17, leading edges 14, 16 of wings 19, engine pylons 18, the leading edges of horizontal stabilizers 20, and the leading edge of a vertical stabilizer 22, to name only a few. The riblets 12 may cover an entire section of a structure, such as the entire nose 17, or only a portion of the section. The placement and area covered by the riblets 12 will vary with the aircraft application, but in general the maximum practical coverage may be up to approximately 80 to 85 percent of the wetted area of the aircraft 10. By optimizing the size and geometry of the riblets 12 as well as their placement, a 2 percent or more reduction in drag may be achieved by the aircraft 10 at cruise altitudes.

Attention is now directed to FIGS. 2-4 which illustrate the riblets 12 in more detail. The riblets 12 comprise an alternating series of parallel ridges 26 and grooves 28 which extend approximately parallel to the airflow 15 over the aircraft 10. In the illustrated embodiment, each of the ridges 26 is formed by two adjacent walls 31, 33 that may converge at their upper extremities. The grooves 28 are defined by the opposing walls 31, 33 of adjacent ridges 26, and a flat base 30.

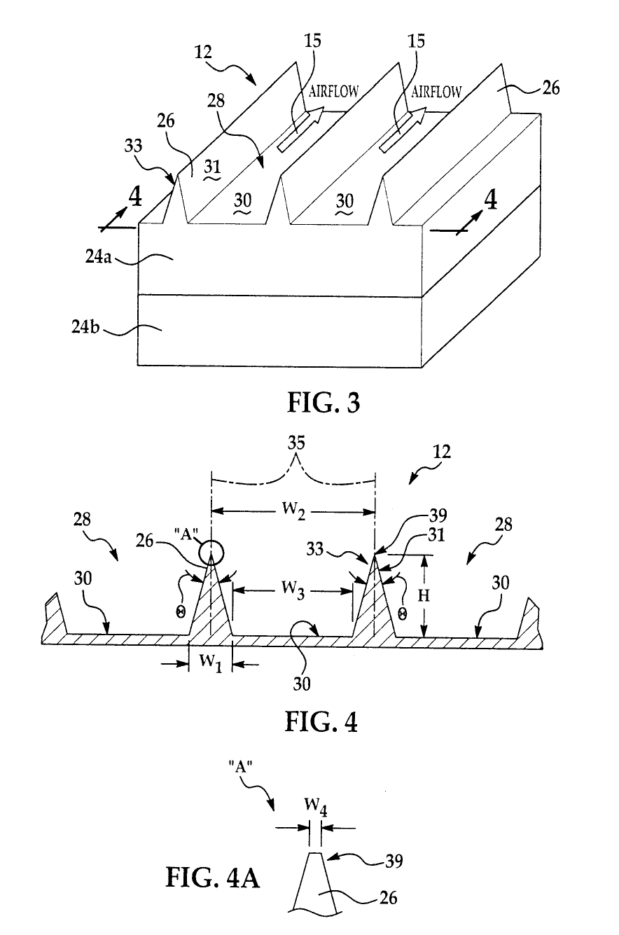

The riblets 12 are molded on the upper surface of a substrate 24 which may, as will be described below, comprise the outer skin of the aircraft 10 that is formed from composite materials. FIG. 3 shows the riblets 12 as being integrally formed on the upper surface of multiple plies 24a, 24b of composite material, such as carbon fiber epoxy. The exact orientation of the riblets 12 on aerodynamic surfaces 15 of the aircraft 10 may vary, depending upon the geometry and airflow over surfaces 15. The riblets 12 may include electrically conductive nano-particles (not shown) which function to conduct electrical current in the event of a lightning strike on the aircraft 10.

Referring particularly to FIGS. 4 and 4a, the dimensions of features forming the riblets 12 will vary depending upon the application. Each of the ridges 26 has a height H and a width W₁ at its base. The centerlines 35 of the ridges 26 are spaced apart a distance W₂, while the base 30 has a width W₃. The top 39 of each ridge 26 has a width W₄. The walls 31, 33 of each ridge 26 form an acute angle θ. The exact values of W₁, W₂, W₃, W₄, H and θ may be selected so as to maximize the drag reduction effect of the riblets 12 while assuring that the chosen geometry and dimensions of the riblets 12 may be practically and consistently manufactured while maintaining necessary tolerances. For example, in one application of the riblets 12 used for a transport airplane cruising in the range of 0.80 to 0.85 Mach at altitudes from 33000 to 39000 feet, the following values may be used:

W₁<approximately 0.001 inches

W₂=approximately 0.00285 inches to 0.00315 inches

W₃=approximately 0.0019 inches to 0.0025 inches

W₄<approximately 0.00006 inches

H=approximately 0.0018 inches to 0.00135 inches

θ=approximately between 25 degrees and 35 degrees

The tops 39 of the ridges 26 should preferably be as sharp as possible (i.e. minimum width W₄) in order to achieve maximum aerodynamic effectiveness. The base 30 should be as smooth and flat as possible.

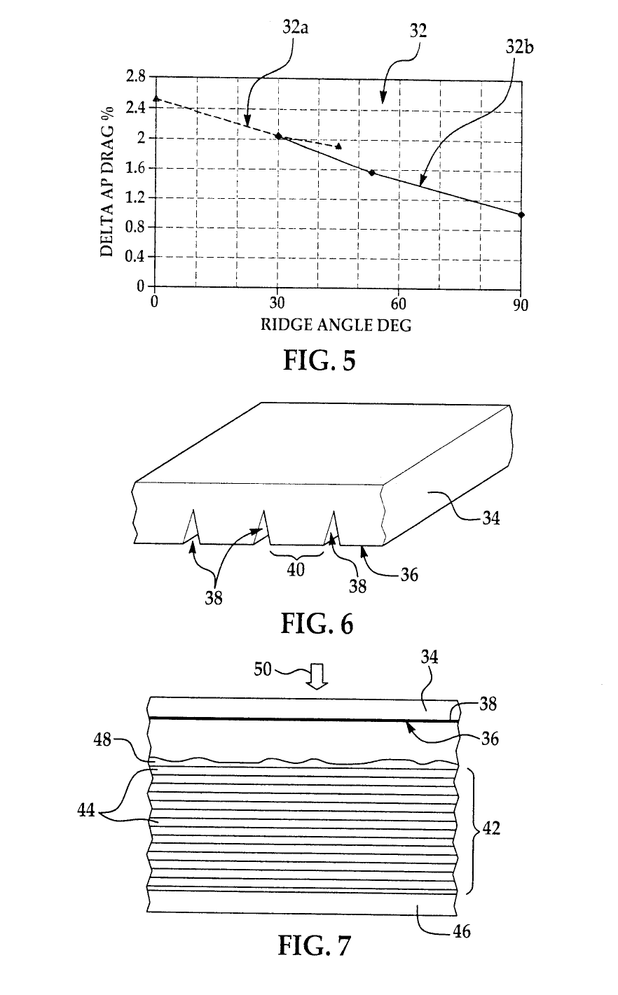

FIG. 5 is a graphical illustration of the relationship between the change in angle θ and the corresponding change in the reduction of drag. The relationship between θ and the reduction in drag is shown by curve 32 comprising a first portion 32a derived from technical literature and a second portion 32b representing empirical data generated by wind tunnel testing. As can be seen from the curve 32, smaller angles of θ provide higher values of drag reduction. For example, increasing angle θ from 30 degrees to 53 degrees may result in a loss of approximately 25 percent of the drag reduction.

In accordance with disclosed embodiments, the riblets 12 may be applied to aerodynamic surfaces 15 either at the time the aircraft 10 is manufactured or after the aircraft 10 has been placed in service. Referring now to FIGS. 6 and 7, according to one method embodiment, the riblets 12 may be formed on the aerodynamic surfaces 15 by forming a layup 42 of composite material plies 44 which may comprise, for example and without limitation, carbon fiber epoxy prepreg. The plies 42 may be later compacted to form the outer skin of the aircraft or a composite structure that includes the outer skin. The layup 42 is supported on a mold base 46. A layer of moldable material 48 is applied over the layup 42. Alternatively, the moldable material 48 may be applied over the lower surface 36 of a mold tool 34. The layer of material 48 will later be molded to form the riblets 12, which, after curing, will be integrally formed with the underlying composite material, i.e. layup 42. The moldable material 48 may comprise, for example and without limitation, a resin or an adhesive commonly used in the fabrication of composite structures.

The lower surface 36 of the mold tool 34 is configured to mold the layup 42 into the desired shape. In the illustrated example, both the mold base 46 and the mold tool 34 are flat, however it is to be understood that various other shapes may be used, particularly curved geometries used to produce leading edges of aircraft. The mold tool 34 includes a lower surface 36 in which a plurality of parallel, V-grooves are formed, separated by an uninterrupted flat surface 40. The V-grooves 38 may be formed by mechanical scribing, laser milling or etching, roll forming, grinding, EDM (electrical discharge machining) or other known techniques. The V-grooves 38, along with the flat surfaces 40, form a complement of riblet profile shown in FIGS. 3 and 4.

After the layup 42 and the material layer 48 have been placed on the tool base 46, the mold is closed and the mold tool 34 contacts layer 48. Force is applied in the direction of the arrow 50, compressing the layup 42. This compaction pressure results in the mold material 48 filling the V-grooves 38, thereby molding the riblets 12 into the surface of the layup 42. The force applied by the mold tool 34 to the material 48, forces the material to flow slightly down into the upper plies 44. Accordingly, upon curing, the resulting riblets 12 essentially form an integral part of the compacted layup 42, and thus an integral part of the outer skin 21 of the aircraft 10.

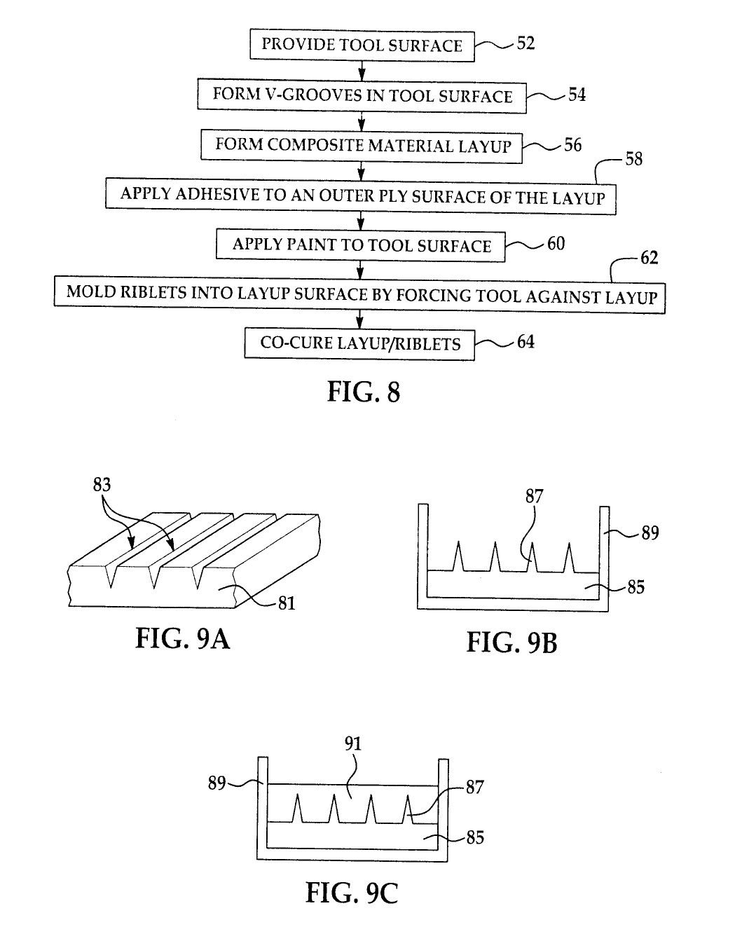

The fabrication procedure just described is also illustrated in the flow diagram shown in FIG. 8. The process begins at step 52 with providing a tool surface 36. Next at 54, parallel V-grooves 38 are formed in the tool surface 36 by a mechanical scribing, laser etching or other processes, as previously described. At step 56 a composite material layup 42 or perform is formed which includes multi-plies 44 of a prepreg for example.

Next, at step 58, a layer 48 of adhesive or other moldable, uncured material is applied to the top ply 44 of the layup 42. Then, at step 60, if desired, a paint and/or UV inhibitor may be applied over the mold tool surface 36, including within the V-grooves 38. The paint applied at step 60 imparts a desired color to the riblets 12 and may act as a protective wear coating during service. The UV inhibitor may be required in order to prevent or inhibit breakdown of the material forming the riblets 12 as a result of UV radiation. Also, electrically conductive nano-particles may be incorporated into the paint or the UV inhibitor to aid in conducting possible lightning strikes. At step 62, the mold tool 34 is forced against the layup 42, resulting in the mold surface 36 contacting the layer 48 of moldable material which fills the V-grooves 38, as additional compaction pressure is applied. Finally, at step 64, the layup 42 and integral riblets 12 are co-cured using conventional procedures.

Alternate techniques may be employed to form a tool that is used to mold the riblets 12. For example, referring to FIGS. 9a-9c, a metallic or non-metallic film or foil tool 81 may be fabricated which integrally incorporates grooves 83 used to mold the riblets 12. A form 85 having ridges 87 may be placed in a mold vessel 89. A suitable liquid which may comprise a metal or a synthetic material is introduced into vessel 89, covering the form 89. When the liquid 91 cools or cures, it solidifies into a solid foil or film 81, which then may be placed over the moldable material 48 and used as a tool for molding the riblets 12, similar to the mold tool 34.

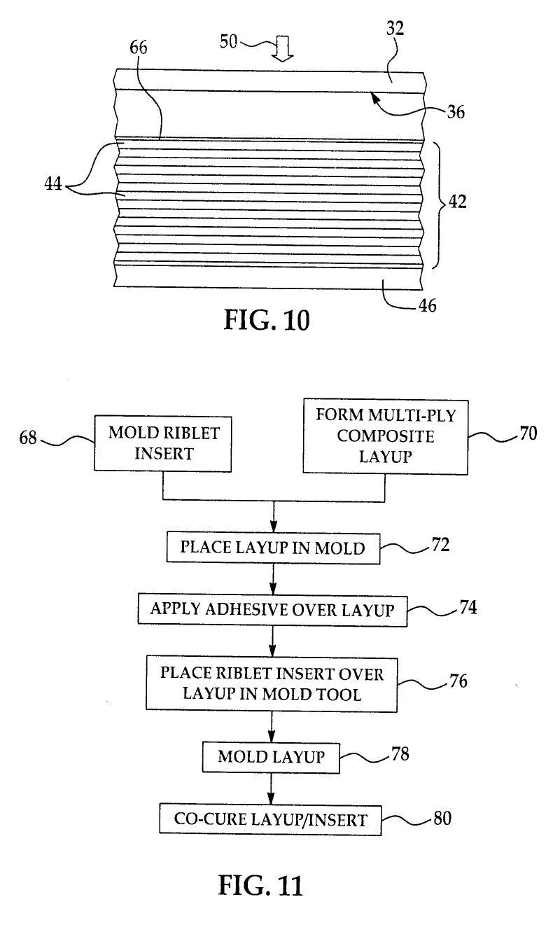

Reference is now made to FIGS. 10 and 11 which depict an alternate method embodiment. In this embodiment, a pre-molded riblet insert part 66 is placed on the layup 42 which is supported on the mold base 46. The insert part 66 has been pre-molded with integrally formed riblets 12, and may or may not be fully cured. A mold tool 32 includes a substantially smooth tool surface 36 which is adapted to engage the insert part 66. The steps of this process are shown more particularly in FIG. 11. The riblet insert 66 is molded at step 68, using any of various mold materials and techniques, including, for example, without limitation, compression molding of a resin such as epoxy.

A multi-ply composite layup is formed at step 76. At step 72, the layup 42 is placed on the mold base 46, following which, at step 74, an adhesive is applied over the top ply 44 of the layup 42, as shown at step 74. Next, at step 76, the part insert 66 is placed over the layup 44, in contact with the adhesive. At step 78, the mold is closed and force is applied to the mold tool 32 which results in molding of the layup 44. Finally, at step 80, the molded layup 44 and the riblet insert 66 are co-cured.

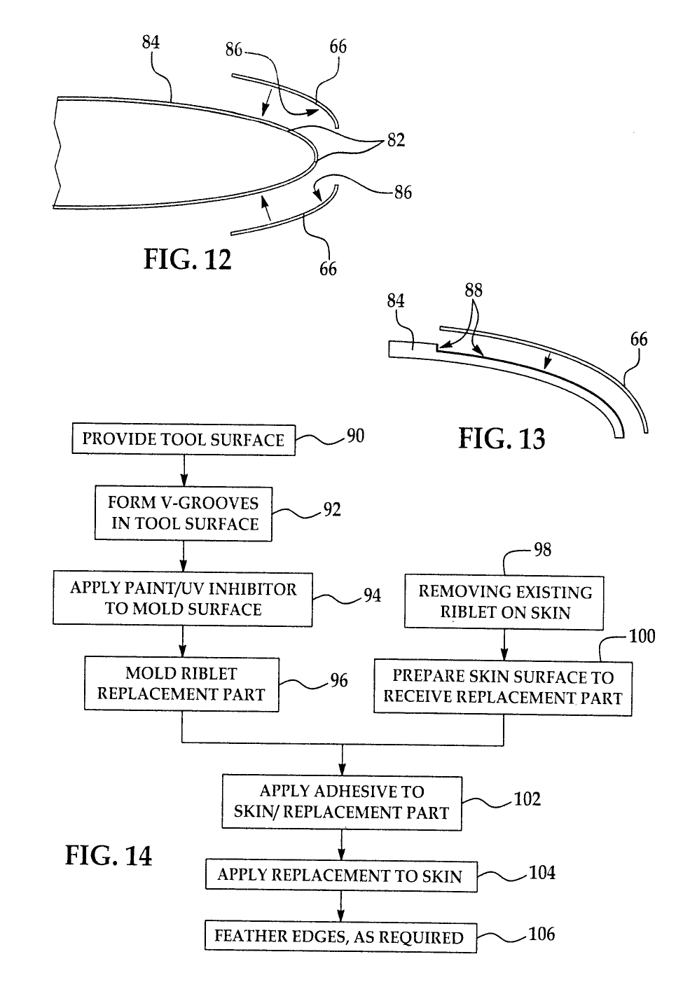

Referring now to FIG. 12, it may be possible to retro-fit pre-molded, substantially rigid riblet parts 66 directly to existing aerodynamic structures, such as leading edges 82 of a wing 84. The riblet insert 66 may be formed, for example and without limitation by compression molding a material such as epoxy resin, wherein the inner surface 86 of the riblet part 66 is molded to match the contour of the leading edges 82. Depending upon the thickness of the riblet part 66, it may be necessary to remove, as by grinding, a thin layer (nor shown) of the surface material on the leading edges 82.

Similarly, as shown in FIG. 13, it may be possible to use pre-molded riblet insert parts 66 to replace damaged or worn riblets 12 on an aerodynamic structure such as the wing 84. In this application, at least a part of a layer of the wing, typically the outer skin, is removed as by grinding, leaving a slightly notched or recessed section 88 having a depth at least equal to the thickness of the riblet insert part 66. The insert part 66 may be bonded to the wing 84 using a suitable adhesive.

A process for reworking and/or repairing riblets 12 on an aerodynamic structure is shown in FIG. 14. Beginning at step 90, a tool surface 36 is provided and at step 92, V-grooves 38 are formed in the tool surface 36 using the techniques previously described. At step 94, paint and/or an UV inhibitor are applied to the mold surface 36. A riblet replacement part 66 is then molded at step 96 using a conventional resin and compression molding or other similar techniques. In parallel with steps 90-96, as shown at step 98, existing riblets 12 on the outer skin of the structure 86 are removed, using conventional techniques such as grinding. After grinding away a portion of the outer skin, a notch or recess 88 is formed which is prepared to receive the replacement riblet part 66, as shown in step 100. This surface preparation may include using solvents, for example to clean the surface in order to assure a good bond will be achieved.

At step 102, a suitable adhesive is applied to the prepared surface of the structure 86 and/or the replacement part 66. Then at step 104, the replacement part 66 is bonded to the structure 86 and any gaps that may exist between part 66 and structure 86 may be filled. Finally, at step 106, any rough edges that may be present between the newly applied replacement part 66 and surrounding areas of the structure 86 may be feathered, as by grinding or sanding.

It should be noted here that although the steps of the method embodiments disclosed above have been described as being carried out in a particular order for illustrative purposes, it is possible to perform the steps of these methods in various other orders.

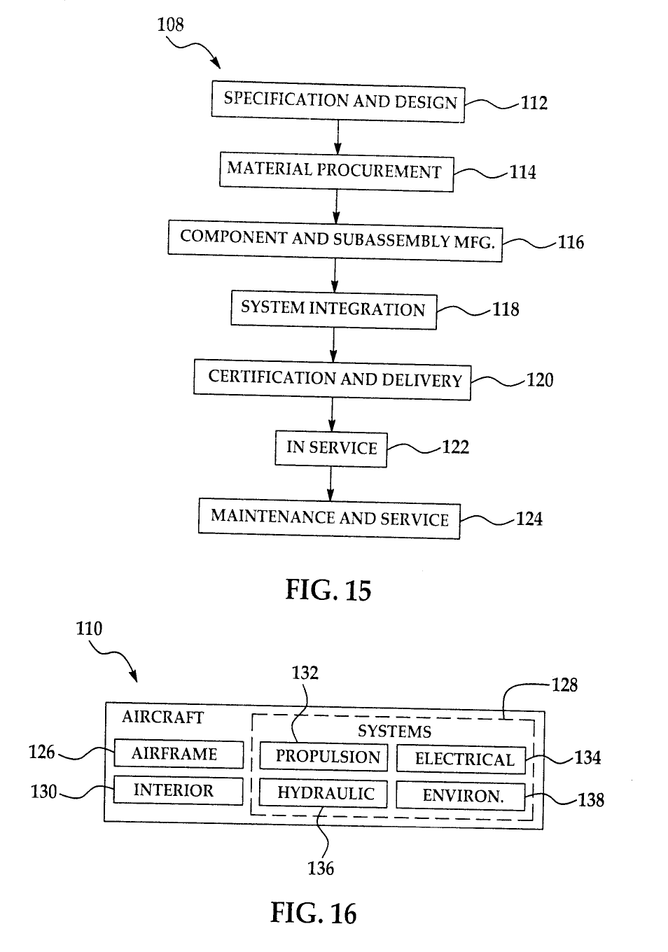

Embodiments of the disclosure may find use in a variety of potential applications, particularly in the transportation industry, including for example, aerospace and automotive applications. Thus, referring now to FIGS. 15 and 16, embodiments of the disclosure may be used in the context of an aircraft manufacturing and service method 108 as shown in FIG. 15 and an aircraft 110 as shown in FIG. 16. Aircraft applications of the disclosed embodiments may include, for example, without limitation, composite stiffened members such as fuselage skins, wing skins, control surfaces, hatches, floor panels, door panels, access panels and empennages, to name a few. During pre-production, exemplary method 108 may include specification and design 112 of the aircraft 110 and material procurement 114. During production, component and subassembly manufacturing 116 and system integration 118 of the aircraft 110 takes place. Thereafter, the aircraft 110 may go through certification and delivery 120 in order to be placed in service 122. While in service by a customer, the aircraft 110 is scheduled for routine maintenance and service 124 (which may also include modification, reconfiguration, refurbishment, and so on).

Each of the processes of method 108 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 16, the aircraft 110 produced by exemplary method 108 may include an airframe 126 with a plurality of systems 128 and an interior 130. Examples of high-level systems 128 include one or more of a propulsion system 132, an electrical system 134, a hydraulic system 136, and an environmental system 138. Any number of other systems may be included. Although an aerospace example is shown, the principles of the disclosure may be applied to other industries, such as the automotive industry.

Apparatus and methods embodied herein may be employed during any one or more of the stages of the production and service method 108. For example, components or subassemblies corresponding to production process 108 may be fabricated or manufactured in a manner similar to components or subassemblies produced while the aircraft 110 is in service. Also, one or more apparatus embodiments, method embodiments, or a combination thereof may be utilized during the production stages 116 and 118, for example, by substantially expediting assembly of or reducing the cost of an aircraft 110. Similarly, one or more of apparatus embodiments, method embodiments, or a combination thereof may be utilized while the aircraft 110 is in service, for example and without limitation, to maintenance and service 124.

Although the embodiments of this disclosure have been described with respect to certain exemplary embodiments, it is to be understood that the specific embodiments are for purposes of illustration and not limitation, as other variations will occur to those of skill in the art.

1. A method of forming riblets in aerodynamic surfaces to reduce drag, comprising:
forming a composite material layup;
applying a layer of adhesive to the layup;
molding the riblets into a an adhesive-covered surface of the layup; and
curing the layup.

2. The method of claim 1, further comprising:
forming a plurality of parallel grooves in the surface of a tool, and
wherein the step of molding the riblets includes using the tool to mold the riblets.

3. The method of claim 1, further comprising:
the step of molding the adhesive layer to form the riblets.

4. The method of claim 2, further comprising:
before the step of molding the riblets, applying a paint to the tool surface.

5. The method of claim 1, wherein:
forming a composite material layup includes stacking plies of prepreg material and applying a layer of uncured resin to the stacked plies, and,
molding the riblets includes forcing a grooved tool face into contact with the layer of uncured resin.

6. A method of forming aerodynamic surface features on the outer skin of an aircraft, comprising:
molding a generally rigid part having the approximate shape of the skin and including an outer surface having a plurality of substantially parallel riblets over which air may flow; and,
applying the part to the skin.

7. The method of claim 6, further comprising:
forming a plurality of substantially parallel grooves in the surface of a tool, and
wherein the step of molding the part is performed using the tool.

8. The method of claim 7, further comprising:
applying a paint to the tool surface after the step of forming the grooves.

9. The method of claim 6, further comprising:
forming a layup of composite materials;
placing the part over the layup;
compacting the layup and the part in a mold; and
co-curing the part and the layup.

10. The method of claim 6, further comprising:
removing a layer of material from a section of the skin, and
wherein the step of applying the part to the skin includes placing the part over the section of the skin where the material has been removed.

11. The method of claim 10, further comprising:
applying an adhesive between the part and the skin section.

12. A method of reworking-an outer skin of an aircraft, comprising:
removing a layer of material from a section of the skin;
molding an insert having the same general shape as the layer of material that has been removed, including forming a plurality of parallel riblets in the outer surface of the insert; and,
replacing the layer of material with the insert.

13. The method of claim 12, further comprising:
forming a plurality of substantially parallel grooves in the surface of a tool, and
wherein step of molding the insert is performed using the tool.

14. The method of claim 13, further comprising:
applying a paint to the tool surface after the grooves have been formed.

15. The method of claim 12, wherein replacing the layer of material includes introducing an adhesive between the insert and the skin.

16. The method of claim 12, wherein removing the layer of material includes grinding away riblets that are present on the skin.

17. For use in aerospace vehicles, an aerodynamic structure, comprising:
an outer skin including integrally formed, substantially parallel riblets extending in the direction of airflow over the skin.

18. The aerodynamic structure of claim 17, wherein the riblets include side walls forming an acute angle.

19. The aerodynamic structure of claim 17, wherein the acute angle is between approximately 25 degrees and 35 degrees.

20. The aerodynamic structure of claim 17, wherein the riblets have a height of between approximately 0.0018 inches and 0.00135 inches.

21. The aerodynamic structure of claim 17, wherein the centerlines of the riblets are spaced apart between approximately 0.00285 inches and 0.00315 inches.

22. The aerodynamic structure of claim 17, wherein the riblets each have a base having a width less than approximately 0.001 inches.

23. The aerodynamic structure of claim 17, wherein the outer skin further includes integrally formed, substantially flat grooves between the riblets extending in the direction of airflow over the skin.

24. For use in aerospace vehicles, an aerodynamic structure, comprising:
an outer skin including integrally formed, substantially parallel, alternating riblets and substantially flat grooves extending in the direction of airflow over the skin,
the riblets having—
(i) side walls forming an acute angle of between approximately 25 degrees and 35 degrees,
(ii) a height of between approximately 0.0018 inches and 0.00135 inches,
(iii) center lines spaced apart between approximately 0.00285 inches and 0.00315 inches,
(iv) a base having a width less than approximately 0.001 inches and,
a top having a width of less than approximately 0.0006 inches.

25. A method of forming a structure for aircraft having aerodynamic surface features to reduce skin friction exerted by a turbulent boundary layer at the surface of the skin to reduce drag, comprising:
fabricating a mold tool, including forming a plurality of parallel, V-shaped grooves in a surface of the tool;
forming a multi-ply layup of uncured composite materials;
placing the layup in the mold tool;
applying a layer of moldable material over the layup;
closing the mold tool;
applying pressure to the mold tool to compact the layup and force the V-grooves into the moldable material so as to integrally form substantially parallel riblets in the outer surface of the compacted layup; and
co-curing the layup and the moldable material.
